(19) United States
(12) Patent Application Publication
(10) Pub. No.: US 2024/0396064 A1
(43) Pub. Date: Nov. 28, 2024

(54) ELECTROLYTE TANK VOLUME REBALANCING

(71) Applicant: ESS TECH, INC., Wilsonville, OR (US)

(72) Inventor: Craig Evans, Durham, NC (US)

(21) Appl. No.: 18/674,401

(22) Filed: May 24, 2024

Related U.S. Application Data
(60) Provisional application No. 63/504,159, filed on May 24, 2023.

(51) Int. Cl. H01M 8/04276; H01M 8/04082; H01M 8/0444; H01M 8/04537; H01M 8/04746; H01M 8/18

(52) U.S. Cl. CPC H01M 8/04276; H01M 8/04201; H01M 8/04477; H01M 8/04611; H01M 8/04746; H01M 8/188

(57) ABSTRACT

Systems and methods are provided for a redox flow battery system. In one example, the redox flow battery system includes an electrolyte storage tank having a first chamber and a second chamber, and a mixing valve fluidically coupling the first chamber to the second chamber. The mixing valve may be selectively opened according to predetermined duty cycles to allow exchange of electrolyte between the first chamber and the second chamber.

### CROSS-REFERENCE TO RELATED APPLICATIONS

The present application claims priority to U.S. Provisional Application No. 63/504,159 entitled “ELECTROLYTE TANK VOLUME REBALANCING” filed May 24, 2023. The entire contents of the above identified application is hereby incorporated by reference for all purposes.

### FIELD

The present description relates generally to a redox flow battery system.

### BACKGROUND AND SUMMARY

Redox flow batteries are suitable for grid scale storage applications due to their capability for scaling power and capacity independently, as well as for charging and discharging over thousands of cycles with reduced performance losses in comparison to conventional battery technologies. Iron hybrid redox flow batteries are particularly attractive due to the incorporation of low cost materials in the cell stack. The iron redox flow battery (IFB) relies on iron, salt, and water for electrolyte, where a composition of the electrolyte is the same for a negative electrolyte and a positive electrolyte of the IFB.

By utilizing a common electrolyte composition for both a negative and a positive side of the IFB, the negative and the positive electrolyte may be mixed in an electrolyte storage system of the IFB, during suitable conditions. In one example, the electrolyte storage system may include a multi-chambered electrolyte storage tank comprising a negative electrolyte chamber for storing the negative electrolyte, and a positive electrolyte chamber for storing the positive electrolyte. The negative electrolyte chamber may be separated from the positive electrolyte chamber by, for example, a bulkhead positioned therebetween, which may include a spillover or overflow hole for maintaining a balance in volume between the chambers. Hydrogen gas may be stored in a head space above the electrolyte chambers, thereby providing spontaneous gas-liquid separation while providing an inert gas blanket for the electrolyte. As such oxidative and system capacity losses may be lessened. By incorporating the multi-chambered electrolyte storage tank into the electrolyte storage system rather than standalone tanks for each electrolyte, a number of auxiliary process units, such as gas/liquid separators and dedicated gas storage tanks, may be reduced. Manufacturing and operational complexity of the IFB may be decreased as a result, as well as its system footprint.

The inventors herein have recognized issues with the multi-chambered electrolyte storage tank described above, however. In one example, during cycling of the IFB, water may flow across a separator arranged between a negative electrode compartment and a positive electrode compartment of the redox flow battery due to electro-osmotic drag. In some instances, movement of the water may be asymmetric, e.g., may favor flow in one direction across the separator, during operation of IFB. Over time, electrolyte volumes in the chambers may change and become unbalanced. For example, a volume of the negative electrolyte in the negative electrolyte chamber of the multi-chambered electrolyte storage tank may become greater or less than a volume of the positive electrolyte in the positive electrolyte chamber. Furthermore, concentrations of supporting salts and active materials in the negative electrolyte chamber versus the positive electrolyte chamber may diverge over repeated cycling. Such differences in volume and concentrations may have adverse effects on an efficiency, capacity, and durability of the IFB.

Although the spillover hole in the bulkhead of the multi-chambered electrolyte storage tank allows for rebalancing of electrolyte volumes between the chambers, the spillover hole may be positioned at a height corresponding to maximum volume capacities of the chambers. Thus the spillover hole may be primarily configured to mitigate overfilling of the chambers and fluidically couple gas head spaces of the chambers. Providing additional passive strategies to rebalance the electrolyte volumes, such as incorporating an additional hole at a lower height than the spillover hole to allow electrolyte crossover, may cause undesirable migration of electrolyte constituents between the chambers during certain operating conditions of the IFB (e.g., during operation in a discharge mode). A mechanism for rebalancing electrolyte volume between the chambers of the multi-chambered electrolyte storage tank that does not degrade efficient operation of the IFB is therefore desirable.

As one example, the issues described above may be at least partially mitigated by a redox flow battery system that includes an electrolyte storage tank having a first chamber and a second chamber, and a mixing valve fluidically coupling the first chamber to the second chamber. The mixing valve may be selectively opened according to predetermined duty cycles to allow exchange of electrolyte between the first chamber and the second chamber. In this way, electrolyte volume may be selectively rebalanced after the IFB is discharged, allowing a capacity of the IFB to be restored and maintained.

Furthermore, by incorporating the mixing valve into the redox flow battery system, gas-liquid separation capabilities of the multi-chambered electrolyte storage tank may be maintained. The mixing valve may be a simple and low cost mechanism enabling electrolyte volume equalization that may be adapted to already existing systems. The mixing of the positive and negative electrolyte chambers may be achieved in a controlled manner that allows the mixing to occur under suitable conditions and not under unsuitable conditions. As a result, a performance and longevity of the IFB may be increased.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system having a multi-chambered electrolyte storage tank with a mixing valve.

FIG. 2 shows an example of a layout of the redox flow battery system of FIG. 1, including the multi-chambered electrolyte storage tank.

FIG. 3 shows a graph depicting examples of mixing valve duty cycle plotted relative to battery SOC and opening of a mixing valve.

FIG. 4 shows an example of a method for rebalancing electrolyte volume between chambers of the multi-chambered electrolyte storage tank enabled by the mixing valve.

FIG. 5 shows examples of variations in redox flow battery system operating parameters, including adjustment of a mixing valve.

FIG. 6 shows a graph plotting changes in electrolyte level relative to time for a multi-chambered electrolyte storage tank of FIG. 1 with and without use of a mixing valve.

FIG. 7 shows a graph plotting battery SOC and electrolyte ferric iron concentration relative to time for the multi-chambered electrolyte storage tank of FIG. 1, comparing results with and without use of the mixing valve.

FIG. 8 shows a graph plotting battery SOC and electrolyte hydroxide concentration relative to time for the multi-chambered electrolyte storage tank of FIG. 1, comparing results with and without use of the mixing valve.

FIG. 9 shows a graph plotting electrolyte pH relative to time for the multi-chambered electrolyte storage tank of FIG. 1, comparing results with and without use of the mixing valve.

### DETAILED DESCRIPTION

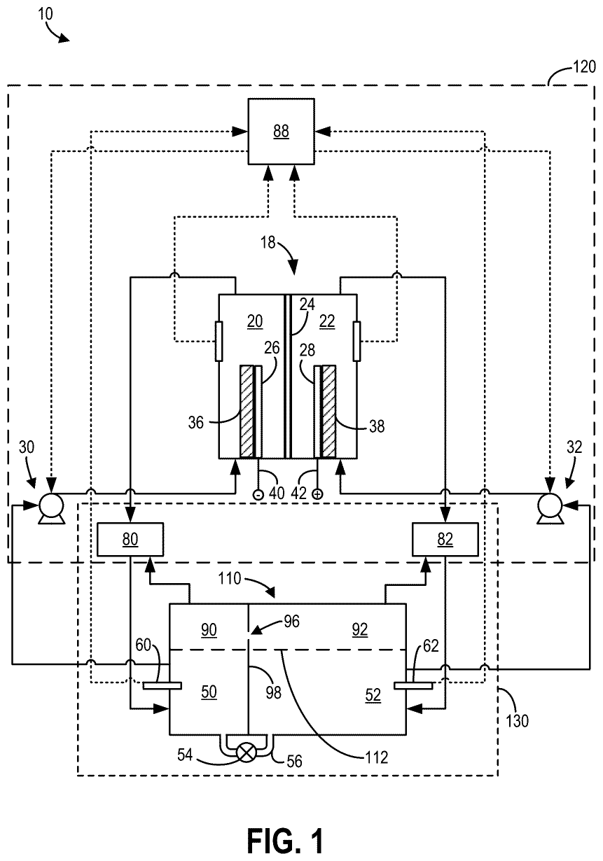

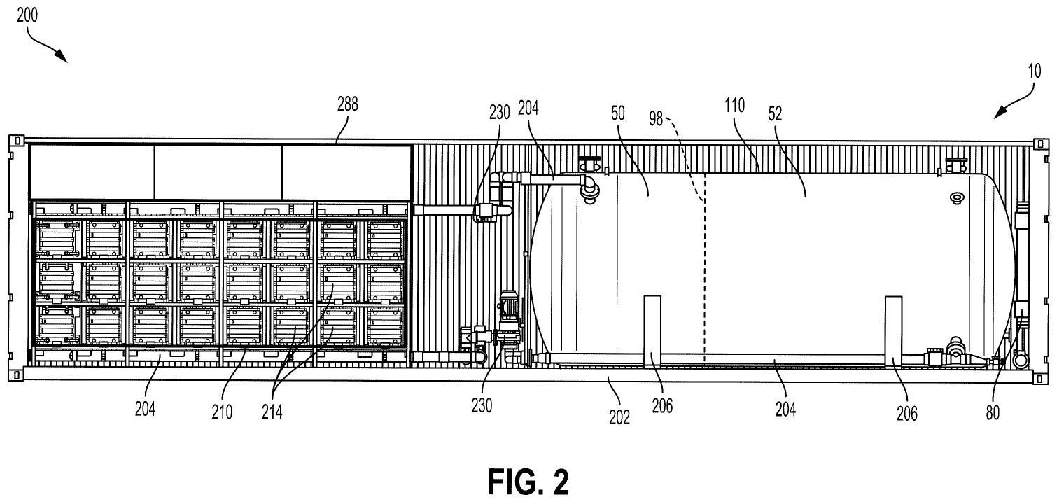

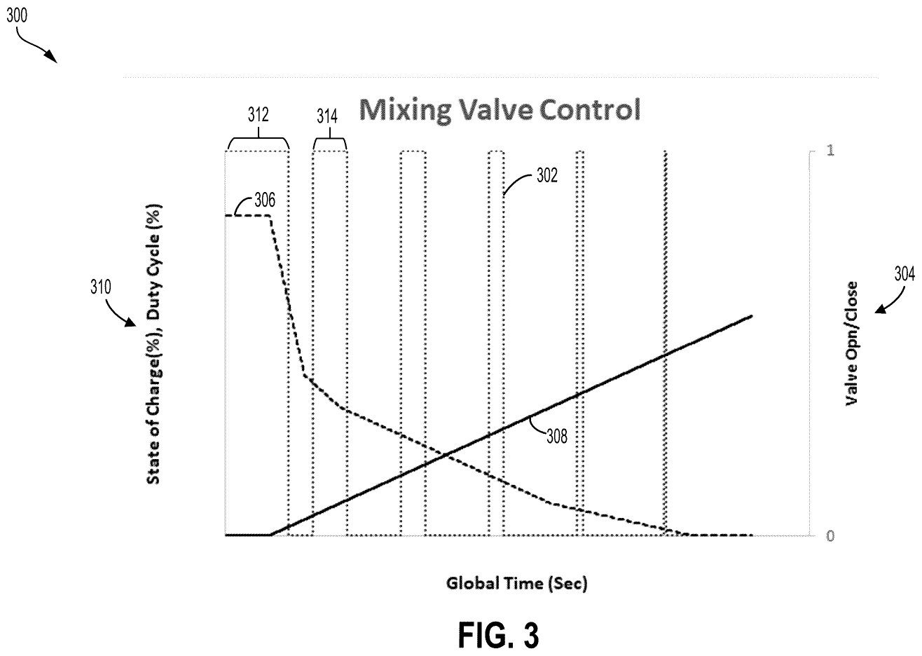

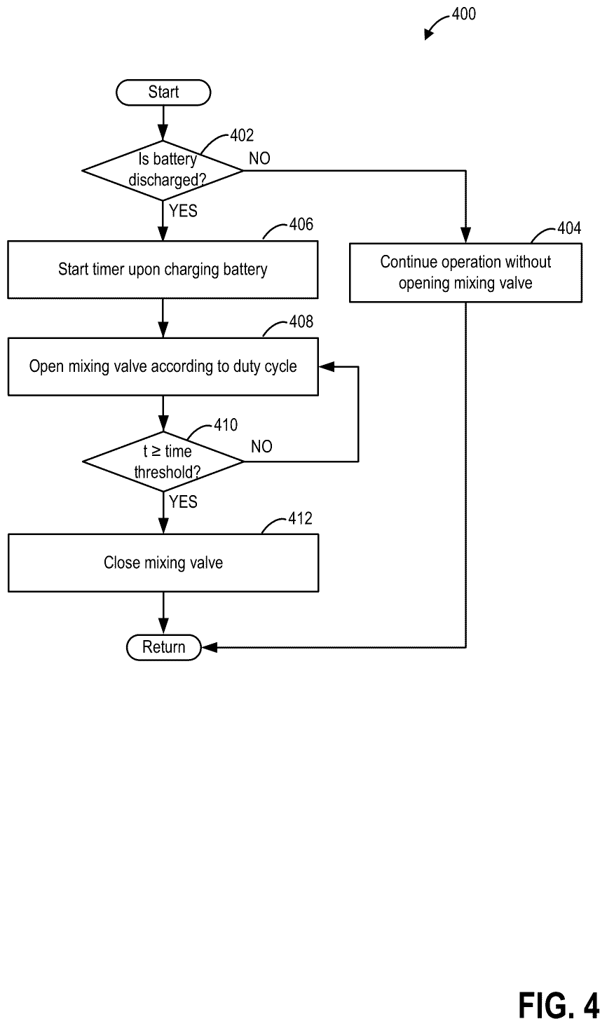

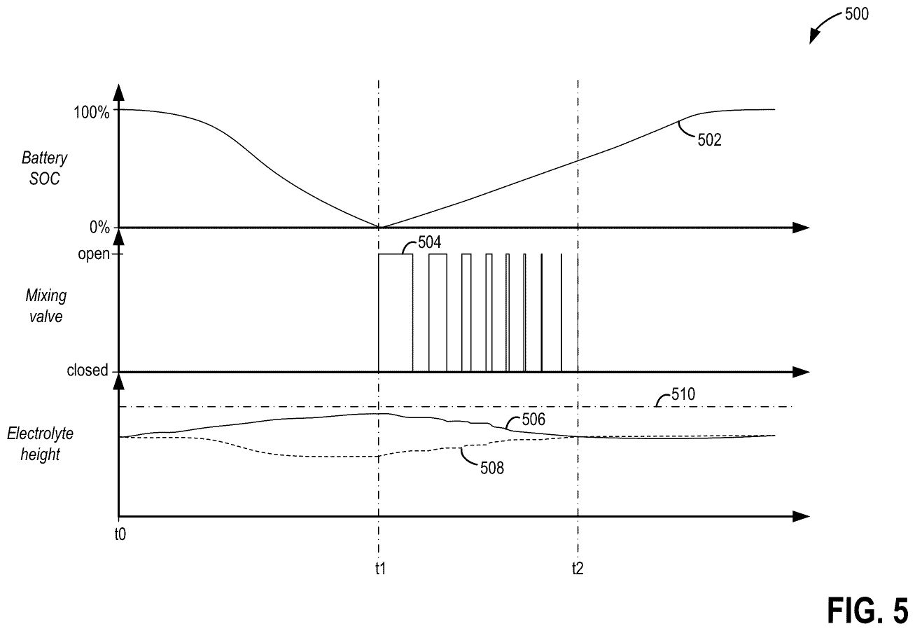

The following description relates to a composition of a high energy density electrolyte for a redox flow battery system. In one example, the redox flow battery system may include an iron redox flow battery (IFB). The redox flow battery system, as illustrated schematically in FIG. 1, may include a multi-chambered electrolyte storage tank configured with a mixing valve for selectively rebalancing electrolyte volume therein. The multi-chambered electrolyte storage tank is also shown in FIG. 2, which depicts a layout of the IFB. The mixing valve may be opened to redistribute and mix electrolyte between chambers of the multi-chambered electrolyte storage tank according to pre-determined duty cycles. The duty cycles may correspond to a state-of-charge (SOC) of the redox flow battery system, as illustrated in a graph overlaying SOC, duty cycle, and opening of the mixing valve in FIG. 3. A method for rebalancing electrolyte volume between chambers of the multi-chambered electrolyte storage tank via the mixing valve is shown in FIG. 4. Variations in operating parameters of the redox flow battery system, including opening of the mixing valve, are shown in FIG. 5 to illustrate relationships between the operating parameters.

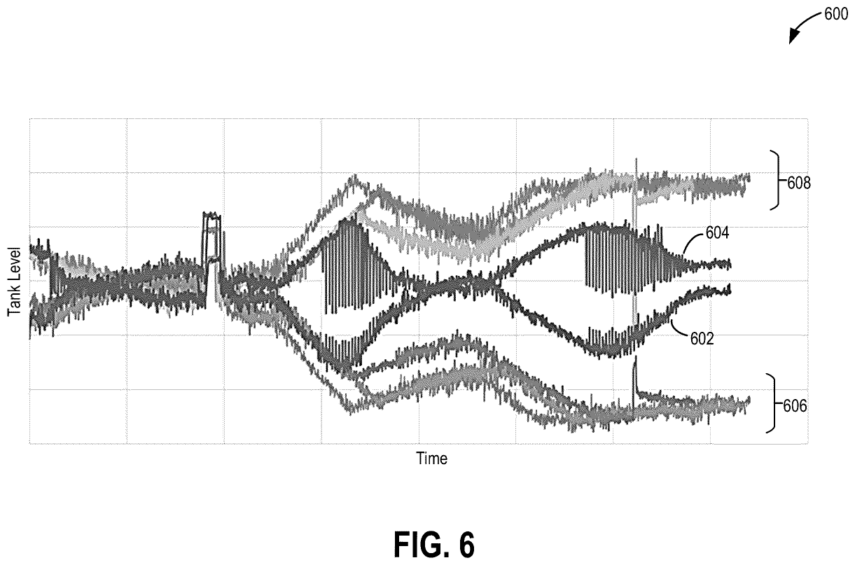

An effect of use of the mixing valve to rebalance electrolyte volume may be observed from experimental testing. Graphs plotting results of the experimental testing, including effects on electrolyte level, electrolyte ferric iron concentration, electrolyte hydroxide concentration, and electrolyte pH plotted relative to time are shown in FIGS. 6-9, respectively. FIGS. 6-9 the experimental testing of the graphs in FIGS. 6-9 are conducted via the electrolyte storage tank of FIG. 1 and compare data with and without use of the mixing valve of FIG. 3.

The results include comparison of data acquired with actuation of the mixing valve, according to the duty cycles described herein, to results obtained without use of the mixing valve.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe³⁺ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

Fe²⁺+2e⁻↔Fe⁰ −0.44 V (negative electrode) (1)

Fe²⁺↔2Fe³⁺+2⁻+0.77 V (positive electrode) (2)

As discussed above, the negative electrolyte used in the IFB may provide a sufficient amount of Fe²⁺ so that, during battery charge, Fe²⁺ may accept two electrons from the negative electrode 26 to form Fe³⁺ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18. It may be appreciated that increasing a concentration of iron in the positive and negative electrolytes may increase a capacity of the IFB system without increasing the volume of electrolyte. In this way, an energy density of the IFB system may be increased.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems. Addition of supporting salts to the electrolytes as described below may allow for an increased iron concentration in the electrolyte solution. Supporting salts may be salts which increase a conductivity of the electrolyte solution and further aid in a stability of the redox active salts (e.g., FeCl₂) but are not oxidized or reduced during the operation of the redox flow battery.

The IFB electrolyte (e.g., FeCl₂, FeCl₃, FeSO₄, Fe₂(SO₄)₃, and the like) may be readily available and may be produced at low costs. The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, a separator 24 (e.g., a membrane separator), and the positive electrode compartment 22. The separator 24 may include an electrically insulating ionic conducting barrier which prevents bulk mixing of the positive electrolyte and the negative electrolyte while allowing conductance of specific ions therethrough. For example, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may also include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions.

FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110, e.g., integrated such that both the negative and the positive electrolytes are stored within a common tank but in separate chambers, may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92 that fluidically couples the gas head spaces 90, 92 to one another. As such, the spillover hole 96 may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors or cells 80 and 82.

As described above, the spillover hole 96 may be located above the fill height 112 at the threshold height. In one example, the threshold height may correspond to a maximum volume of electrolyte that can be stored in the chambers 50 and 52. Self-balancing of the electrolytes between the negative and positive electrolyte chambers 50 and 52 may only occur if the volume in at least one of the chambers reaches the height of the spillover hole 96. As a result, the rebalancing may occur infrequently relative to a tendency for the electrolyte volumes of the chambers to become unbalanced (e.g., differ from one another with respect to the volume of each chamber). Furthermore, by delaying rebalancing of the electrolytes until electrolyte height in one of the chambers reaches the spillover hole 96, a system capacity may be reduced and a likelihood of hydroxide formation may be increased, where the hydroxide formation may lead to loss of electroactive iron.

For example, during charge and discharge operation of the redox flow battery system 10, water may migrate across the separator 24 due to electro-osmotic drag. Furthermore, the water may flow preferentially across the separator 24 in the redox flow battery cell 18, in one direction versus another. For example, the water may migrate from the positive electrode compartment 22 to the negative electrode compartment 20 preferentially, or vice versa, depending on an operating cycle of the redox flow battery system 10. As the redox flow battery 10 is cycled through charge and discharge, volumes in the negative electrolyte chamber 50 and the positive electrolyte chamber 52 may become increasingly different while remaining below the height of the spillover hole 96. In addition, supporting salt and electroactive material concentrations may also vary between the chambers over time. An efficiency, capacity, and durability of the redox flow battery system 10 may be degraded by such imbalances in electrolyte volume and supporting salt/electroactive material concentrations.

In order to mitigate adverse effects of electrolyte imbalances between the negative electrolyte and the positive electrolyte, the multi-chambered electrolyte storage tank 110 may be configured with a mixing valve 54. The mixing valve 54 may be arranged in a passage or conduit 56 fluidically coupling the negative electrolyte chamber 50 and the positive electrolyte chamber 52 to one another. The mixing valve 54 may be adjustable between an open position and a closed position. For example, when the mixing valve 54 is closed, e.g., adjusted to the closed position, electrolyte may not flow between the negative electrolyte chamber 50 and the positive electrolyte chamber 52. When adjusted to the open position, electrolyte flows through the mixing valve 54 in a direction dependent on a pressure difference between the chambers. For example, the pressure may be higher in the negative electrolyte chamber 54 compared to the positive electrolyte chamber 52, pushing electrolyte flow to the positive electrolyte chamber 52, and vice versa. Electrolyte exchange between the chambers may therefore be controlled based on the opening of the mixing valve 54. In one example, rebalancing of electrolyte between the chambers may be achieved according to a duty cycle of the mixing valve 54, as described further below with reference to FIGS. 4 and 5.

In one example, a position of the mixing valve 54, and therefore electrolyte exchange between the chambers of the multi-chambered electrolyte storage tank 110, may be controlled based on signals from a timer, e.g., a clock, and a sensor monitoring the SOC of the redox flow battery system 10. The mixing valve 54 may be opened and closed according to the duty cycle of the mixing valve 54 to maintain a balance between electrolyte in the chambers. By actuating the mixing valve 54 based on its duty cycle, redistribution of electrolyte between the chambers may be facilitated when the redox flow battery system 10 is in an optimal state for electrolyte mixing. When mixing valve 54 is selectively opened, the electrolyte in the chambers of multi-chambered electrolyte storage tank 110 may share a common composition. In addition, rebalancing of the electrolyte within the multi-chambered electrolyte storage tank 110 may be performed at a frequency that maintains an operating efficiency and capacity of the redox flow battery system 10 over longer periods of operation compared to when electrolyte balancing is managed passively by spillover through the spillover hole 96.

While filling multi-chambered electrolyte storage tank 110 and during operation of the redox flow battery system 10, a difference between the liquid levels in the negative and positive electrolyte chambers 50 and 52 may be maintained below a threshold difference, corresponding to a threshold pressure difference. As shown in FIG. 1, the mixing valve 54 and the conduit 56 may be arranged at the bottom of the multi-chambered electrolyte storage tank 110 to allow a pressure differential between the negative and positive electrolyte chambers 50 and 52, the pressure differential arising from a gravitational pull on different stored electrolyte volumes, to drive flow of the electrolyte through the conduit 56 when the mixing valve 54 is open. The bottom of the multi-chambered electrolyte storage tank 110, which corresponds to bottoms of the chambers, may be a region of the storage tank below a fluid level of electrolyte stored in the chambers of the storage tank 110. As long as electrolyte is present in the chambers, the electrolyte may flow out of the chambers through the mixing valve 54 based on gravity.

In other examples, however, the conduit 56, and the mixing valve 54 may be positioned at another region or height along the chambers, other than at the bottom of the multi-chambered electrolyte storage tank 110. For example, the mixing valve 54 may be located along the chambers below an upper region of the chambers, such as below the gas head spaces 90 and 92, while maintaining the mixing valve 54 below the fluid level of the electrolyte. A duty cycle of the mixing valve 54 may be adjusted based on the mixing valve position. In addition, alternative configurations may omit the conduit 56.

The mixing valve 54 may be an electronically actuated valve which, as described above, may be adjustable between open and closed positions. Various types of valves may be used, including pinch valves, ball valves, gate valves, butterfly valves, etc. Further details of operation of the mixing valve 54 are provided below, with reference to FIGS. 3-4.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 or 52 may include one or more heaters. In a configuration where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. Likewise, in a configuration where only the negative electrolyte chamber 54 includes one or more heaters, the positive electrolyte may be heated by transferring heat generated at the redox flow battery cell 18 to the positive electrolyte. The one or more heaters may be actuated by a controller 88 to regulate a temperature of the negative electrolyte chamber 50 and the positive electrolyte chamber 52 independently or together.

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location.

As further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 may be positioned to monitor positive electrolyte and negative electrolyte conditions at the positive electrolyte chamber 52 and the negative electrolyte chamber 50, respectively. It will be appreciated that sensors may be positioned at other locations throughout the redox flow battery system 10 to monitor electrolyte chemical properties and other properties. In this manner, the controller 88 may be responsive to one or a combination of sensors and probes.

The controller 88 may further execute control schemes based on an operating mode of the redox flow battery system 10. For example, the controller 88 may control charging and discharging of the redox flow battery cell 18. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. Herein, the power module 120 may also be referred to as a battery, e.g., a redox flow battery of the redox flow battery system 10. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 and components included therein.

Referring now to FIG. 2, it illustrates a side view of an example redox flow battery system layout 200 for the redox flow battery system 10 of FIG. 1. As such, components common to FIGS. 1 and 2 will not be re-introduced for brevity. Redox flow battery system 10 may be housed within a housing 202 that facilitates its long-distance transport and delivery. In some examples, the housing 202 can include a standard steel freight container or a freight trailer that can be transported via rail, truck or ship. The redox flow battery system layout 200 can include the integrated multi-chambered electrolyte storage tank 110 and one or more rebalancing reactors (e.g., rebalancing reactor 80) positioned at a first side of the housing 202, and a power module 210, and power control system (PCS) 288 at a second side of the housing 202. It will be appreciated that the mixing valve 54 of FIG. 1 may be similarly implemented at the integrated multi-chambered electrolyte storage tank 110 of FIG. 2 but is not shown in FIG. 2 for brevity.

Auxiliary components such as supports 206, as well as various piping 204, pumps 230, valves (not shown at FIG. 2), and the like may be included within the housing 202 (as further described above with reference to FIG. 1) for stabilizing and fluidly connecting the various components positioned therein. For example, one or more pumps 230 may be utilized to convey electrolyte from the integrated multi-chambered electrolyte storage tank 110 to one or more redox flow battery cell stacks 214 within the power module 210. Furthermore, additional pumps 230 may be utilized to return electrolyte from the power module 210 to the negative electrolyte chamber 50 or the positive electrolyte chamber 52 of the integrated multi-chambered electrolyte storage tank 110.

Power module 210 may include one or more redox flow battery cell stacks 214 electrically connected in parallel and/or in series. Each of the one or more redox flow battery cell stacks 214 may further include a plurality of redox flow battery cells, such as the redox flow battery cell 18 of FIG. 1, connected in parallel and/or series. In this way, power module 210 may be able to supply a range of current and/or voltages to external loads. The PCS 288 includes controller 88 of FIG. 1, as well as other electronics, for controlling and monitoring operation of the redox flow battery system 10. Furthermore, PCS 288 may regulate and monitor voltage supplied to external loads, as well as supplying current and/or voltage from external sources for charging of the power module 210. The PCS 288 may further regulate and control operation of the redox flow battery system 10 during an idle state or idle mode. Placement of the redox flow battery system 10 in an idle state may occur when the power module 210 is not in a charge mode or a discharge mode.

In one example, the mixing valve may be actuated to the open or closed positions according to time and a SOC of the redox flow battery system. As such, opening of the mixing valve may be constrained to operation of the redox flow battery system where compositions of negative electrolyte and positive electrolyte of the redox flow battery system are sufficiently similar to allow mixing therebetween. For example, mixing of the electrolytes stored in the chambers of the multi-chambered electrolyte storage tank may be conducted after operation of the redox flow battery system in a discharge mode, e.g., after both equations 1 and 2 proceed according to the reverse reactions to generate Fe²⁺. In particular, the mixing valve may be opened according to a duty cycle after a redox flow battery of the redox flow battery system is discharged to a maximum extent (e.g., the SOC is 0%). In other words, the mixing valve may be closed while the redox flow battery system is operating in the discharge mode and similarly closed when the redox flow battery system is operating in a charge mode without having been previously discharged to 0% SOC. Rebalancing of electrolyte volume and electrolyte mixing between the chambers of the multi-chambered electrolyte storage tank may therefore occur during operation of the redox flow battery system in the charge mode after the redox flow battery has been fully depleted.

Adjustment of the mixing valve between open and closed positions may be actuated based on the redox flow battery SOC over a predetermined period of time, where the predetermined period of time may be a duty cycle of the mixing valve. The duty cycle may represent a period of time that the mixing valve may be maintained open, which may be estimated based on electrolyte height within the chambers of the multi-chambered electrolyte storage tank. For example, as a difference in height between electrolyte levels of the negative electrolyte chamber and the positive electrolyte chamber increases, electrolyte mixing via the mixing valve may increase. Additionally or alternatively, the duty cycle may be estimated based on one or more of a difference in concentrations of supporting salts and/or electroactive materials between the negative electrolyte chamber and the positive electrolyte chamber, and a flow rate through the mixing valve.

Opening of the mixing valve to facilitate rebalancing of electrolyte levels may be constrained to low SOCs to minimize mixing of Fe³⁺.

The mixing valve may be opened multiple times, e.g., pulsed, during operation of the redox flow battery system over a charging cycle, with each period of opening corresponding to the duty cycle determined for the mixing valve based on the current SOC of the redox flow battery. As the SOC increases, the duty cycle of the mixing valve may decrease. In this way, the mixing valve may be adjusted open for a plurality of duty cycles. For example, as illustrated in FIG. 3 and shown in Table 1, a maximum countdown time may be determined to be 600 seconds, which may be a maximum duty cycle of the mixing valve, applied when the redox flow battery is fully depleted (e.g., 0% SOC). The duty cycles of the mixing valve are depicted in Table 1 according to the SOC of the redox flow battery, which may be monitored by one or more sensors, as described above with reference to FIG. 1. As an example, the battery (e.g., the redox flow battery) may be at 0% SOC at a start of the charging cycle. A first duty cycle of the mixing valve may be 100% of the countdown time. The mixing valve may therefore be actuated open for 600 seconds.

When the battery SOC reaches 5%, a second duty cycle of the mixing valve may be performed, where the second duty cycle is 50% of the countdown time. The mixing valve may therefore be actuated open for 300 seconds during the second duty cycle. With each successive duty cycle, the duty cycle may be a progressively shorter portion of the countdown time until the duty cycle reaches 0% by a ninth duty cycle. The mixing valve may remain closed thereafter. As a further example, the opening of the mixing valve according to the duty cycles may be terminated before the SOC reaches 100%. The countdown time may be determined such that the durations of time that the mixing valve is opened for each duty cycle does not overlap with a subsequent duty cycle. For example, the first duty cycle may be completed before the SOC reaches 5%, the second duty cycle may be completed before the SOC reaches 10%, and so on.

TABLE 1
Mixing valve duty cycle actuation.
Base clock countdown: 600 seconds

| Positive battery SOC | Duty cycle | Mixing valve duty cycle |
|---|---|---|
| (%) | number | (as % of countdown) |
| 0 | 1 | 100 |
| 5 | 2 | 50 |
| 10 | 3 | 40 |
| 20 | 4 | 30 |
| 25 | 5 | 25 |
| 30 | 6 | 20 |
| 40 | 7 | 10 |
| 50 | 8 | 5 |
| 60 | 9 | 0 |
| 70 | 10 | 0 |
| 80 | 11 | 0 |
| 90 | 12 | 0 |
| 100 | 13 | 0 |

The opening and closing of the mixing valve is illustrated in FIG. 3 in a graph 300, and represented by a first plot 302 plotted relative to a first y-axis 304 that is positioned along a right side of graph 300. The first y-axis depicts a position of the mixing valve as either open (e.g., y=1) or closed (e.g., y=0). Graph 300 further includes a second plot 306, depicting duty cycle of the mixing valve (as a % of the countdown time), and a third plot 308, depicting the SOC of the battery. The second and third plots 306 and 308 both correspond to a second y-axis 310 positioned along a left side of graph 300, the second y-axis 310 showing both duty cycle and SOC relative to a common set of percentages. Time is provided in seconds (Sec) along an x-axis of graph 300.

As shown in graph 300, the battery is initially at 0% SOC (as shown in the third plot 308) and the duty cycle of the mixing valve is at 100% of the countdown (as shown in the second plot 306). The first duty cycle of the mixing valve (as indicated by a bracket 312 and corresponding to the first duty cycle of Table 1) may represent opening of the mixing valve for a duration equal to the countdown time (e.g., 600 seconds as shown in Table 1). The second duty cycle of the mixing valve (as indicated by a bracket 314 and corresponding to the second duty cycle of Table 1) occurs after the first duty cycle, with respect to the x-axis of graph 300, when the SOC has increased. The mixing valve is opened for a shorter duration of time than the first duty cycle.

As shown in graph 300, each subsequent duty cycle, with respect to time elapsed, is shorter than a previous duty cycle. The mixing valve is therefore pulsed through successively shorter duty cycles over at least a portion of a duration of a charge cycle of the redox flow battery. By opening and closing the mixing valve more than once during the charge cycle, mixing of electrolyte, as the electrolyte flows from a chamber with higher electrolyte height to a chamber with lower electrolyte height, the electrolyte may be allowed to equilibrate between open cycles. Electrolyte height between the chambers may differ when Fe³⁺ concentrations are elevated, which may otherwise result in loss of capacity and formation of ferric hydroxide if spillover from the positive electrolyte into the negative electrolyte chamber occurs. By varying the duty cycle durations, the mixing valve may be opened for a duration of time according to a current SOC.

Referring now to FIG. 4, it shows a method 400 for rebalancing electrolyte volume between chambers (e.g., a negative electrolyte chamber and a positive electrolyte chamber) of a multi-chambered electrolyte storage tank via actuation of a mixing valve. The mixing valve, such as the mixing valve 54 of FIG. 1, may be incorporated into the multi-chambered electrolyte storage tank of a redox flow battery system such as the redox flow battery system 10 of FIGS. 1 and 2. In one example, the redox flow battery system may include an IFB. Method 400 may be executed by a controller, such as the controller 88 of FIG. 1, based on instructions stored at non-transitory memory of the controller. The instructions may include actuation of various actuators of the redox flow battery system based on signals received from sensors of the redox flow battery system, as described above with reference to FIG. 1. For example, the controller may receive signals from a sensor monitoring a SOC of the IFB, from sensors detecting electrolyte level in the chambers of the multi-chambered electrolyte storage tank, from sensors monitoring concentration of electroactive materials and supporting salts in the electrolyte, and from a clock or timer used to monitor time. The controller may use the signals to adjust a position of the mixing valve, e.g., between open and closed, based on algorithms enabling estimation of a suitable countdown time for the redox flow battery system and determination of duty cycles for the mixing valve to rebalance electrolyte levels in the chambers.

At 402, method 400 includes confirming if the battery (e.g., the IFB) is discharged. For example, the battery may be discharged when the SOC is at 0% after delivering power to an electrical load. If the battery is not discharged, method 400 continues to 404 to continue operating the battery without opening the mixing valve. As an example, the battery may continue providing power to the electrical load until the SOC is depleted to 0%. Alternatively, the battery may be in a stand-by or idle mode, where the battery is neither discharging or charging. As yet another example, the battery may be operated in a discharge mode without having been depleted to 0% SOC previously. Method 400 returns to the start.

If the battery is at 0% SOC, method 400 proceeds to 406 to initiate a timer when charging of the battery commences. At 408, method 400 includes opening the mixing valve according to pre-determined duty cycles upon operation of battery in the charging mode. When open, electrolyte may flow through the mixing valve, according to the pressure differential between the chambers, which may cause the electrolyte to flow from the chamber with the higher electrolyte height to the chamber with the lower electrolyte height. For example, the controller may determine the duty cycles via the stored algorithms, or may refer to look-up tables providing relationships between duty cycles, electrolyte height differentials, and battery SOC, amongst others. The mixing valve may be pulsed open according to the durations of time for each duty cycle of a plurality of duty cycles, as described above with respect to FIG. 3, and depicted in Table 1. In one example, rebalancing of electrolyte height between the chambers may be achieved when charging of the battery reaches a SOC of 50%.

At 410, method 400 includes confirming if an amount of elapsed time, with respect to the timer, reaches a time threshold. The time threshold may correspond to the pre-determined duration of time for a specific duty cycle of the mixing valve. For example, with reference to Table 1, the time threshold may be 600 seconds if the mixing valve is opened according to a first duty cycle, or the time threshold may be 300 seconds if the mixing is opened according to a second duty cycle, etc. The time threshold therefore varies depending on a current duty cycle of the mixing valve. If the time threshold is not met, method 400 returns to 408 to maintain the mixing valve open. If the elapsed time reaches the time threshold, method 400 continues to 412 to close the mixing valve. Method 400 returns to the start.

Variations in operating parameters of a redox flow battery system during electrolyte rebalancing in a multi-chambered electrolyte storage tank are depicted in a graph 500. In one example, the redox flow battery system may be the redox flow battery system of FIGS. 1 and 2, adapted with a mixing valve, such as the mixing valve 54 of FIG. 1. The redox flow battery system may include an IFB, which may be charged or discharged according to an operating mode of the redox flow battery system. The mixing valve may be actuated based on pre-determined duty cycles during operation of the redox flow battery system in a charging mode to rebalance electrolyte levels between a negative electrolyte chamber and a positive electrolyte chamber of the multi-chambered electrolyte storage tank.

As shown in graph 500, plot 502 depicts a SOC of the IFB, plot 504 depicts a position of the mixing valve, plot 506 depicts an electrolyte height of the positive electrolyte tank, and plot 508 depicts an electrolyte height of the negative electrolyte tank, with plot 506 and plot 508 overlaid with respect to a common y-axis. Dashed line 510 indicates a height of a spillover hole of the multi-chambered electrolyte storage tank, e.g., the spillover hole 96 of FIG. 1. A y-axis of plot 502 shows percent SOC increasing upwards to a maximum of 100%, a y-axis of plot 504 shows adjustment of the mixing valve between open and closed positions, and the y-axis of the plots 506 and 508 show electrolyte height increasing upwards. Time is shown along an x-axis of graph 500. Notable events in time are indicated in graph 500.

At t0, the IFB is fully charged (e.g., the SOC is 100%, plot 502), the mixing valve is closed (plot 504), and the electrolyte heights in the positive electrolyte chamber and the negative electrolyte chamber are similar (plots 506 and 508, respectively). Between t0 and t1, the IFB is operated in a discharge mode. As the IFB is discharged, the SOC decreases. During discharge, water in the electrolyte may flow across separators of the IFB (e.g., the separator 24 of FIG. 1), due to electro-osmotic drag as redox reactions occur at electrodes of the IFB. As a result, a greater volume of electrolyte may be delivered to and stored at the positive electrolyte chamber of the multi-chambered electrolyte storage tank from a positive electrode compartment of the IFB, than delivered to and stored at the negative electrolyte chamber from a negative electrode compartment of the IFB. The electrolyte heights of the chambers become increasingly different between t0 and t1, with the electrolyte height in the positive electrolyte chamber increasing and the electrolyte height in the negative electrolyte chamber decreasing.

At t1, the IFB is depleted (e.g., the SOC decreases to 0%). Operation of the redox flow battery system is adjusted to a charging mode and the SOC increases between t1 and t2. The mixing valve is opened according to a first duty cycle of the mixing valve. Between t1 and t2, the mixing valve is opened and closed according to the pre-determined duty cycles which may be portions of a countdown time, such as 600 seconds, for example. With each successive opening of the mixing valve, electrolyte may flow from the positive electrolyte chamber to the negative electrolyte chamber due to a pressure difference between the chambers arising from the difference in electrolyte heights. The mixing valve is opened for progressively shorter durations of time with each successive duty cycle and the electrolyte heights of the chambers converge until, at t2, the electrolyte heights become equal.

After t2, the SOC continues to rise as operation of the redox flow battery system proceeds in the charging mode until the IFB is fully charged (e.g., 100% SOC). The mixing valve is maintained closed and the electrolyte heights of the chambers remain relatively uniform and similar to one another. Through the duration of time shown in graph 500, the electrolyte heights in both the positive and negative electrolyte chambers remain below the spillover hole.

In this way, electrolyte may be redistributed between chambers of a multi-chambered electrolyte storage tank of a redox flow battery system to restore a balance in electrolyte volume between the chambers. The electrolyte may be rebalanced by configuring the multi-chambered electrolyte storage tank with a mixing valve that fluidically couples the chambers to one another. During conditions suitable for mixing and exchange of electrolyte between the chambers the mixing valve may be pulsed open, such as during a charging cycle after the redox flow battery system has been fully discharged to a SOC of 0%. Pulsing of the mixing valve may include opening the mixing valve according to progressively shorter duty cycles based on a pre-determined relationship between the SOC of a battery of the redox flow battery system and a percentage of a maximum opening time of the mixing valve for each duty cycle. By fluidically coupling the chambers and opening the mixing valve after battery charge depletion, electrolyte may flow from a chamber of higher electrolyte height to a chamber of lower electrolyte height, thereby restoring a target ratio of negative to positive electrolyte in the multi-chambered electrolyte storage tank. Furthermore, exchange of electrolyte between the tanks may assist in maintaining balanced concentrations of supporting salts and electroactive materials in the chambers. Redistribution of the electrolyte via the mixing valve may enable more frequent rebalancing of the electrolyte between the chambers, thereby minimizing formation of hydroxides and circumventing capacity and efficiency losses that may otherwise occur if relying solely on a spillover hole of the multi-chambered electrolyte storage tank to provide overflow redistribution. As a result, a power output and useful lifetime of the redox flow battery system may be maintained high.

Evidence supporting an effectiveness of the mixing valve for maintaining the performance of the redox flow battery system, as described herein, may be demonstrated via experimental testing results. For example, a graph 600 is shown in FIG. 6 comparing electrolyte levels between chambers of a multi-chambered electrolyte storage tank with a mixing valve, such as the multi-chambered electrolyte storage tank 110 of FIGS. 1-2, to electrolyte levels of the chambers when the mixing valve is not used. Electrolyte level of a chamber (e.g., either a negative or positive electrolyte chamber) of the multi-chambered electrolyte storage tank (hereafter, storage tank, for brevity) is depicted along the y-axis of graph 600 and time is shown along the x-axis.

Graph 600 includes a first plot 602 representing electrolyte level in a negative electrolyte chamber of the storage tank with the mixing valve used, and a second plot 604 representing electrolyte level in a positive electrolyte chamber of the storage tank, also with the mixing valve used. A first set of plots 606 represents electrolyte level in the negative electrolyte chamber of the storage tank without use of the mixing valve while a second set of plots 608 show electrolyte level in a positive electrolyte chamber of the storage tank also without use of the mixing valve.

Over a duration of time shown in graph 600, the first plot 602 and the second plot 604 periodically converge, where periods of convergence correspond to charging cycles where the mixing valve is opened according to pre-determined duty cycles, as described above with reference to FIG. 3 and Table 1. In contrast, the first set of plots 606 and the second set of plots 608 diverge from one another, e.g., the electrolyte levels become more different, over time. Use of the mixing valve may therefore maintain more balanced electrolyte levels over time between a positive electrolyte chamber and a negative electrolyte chamber than when the mixing valve is not used.

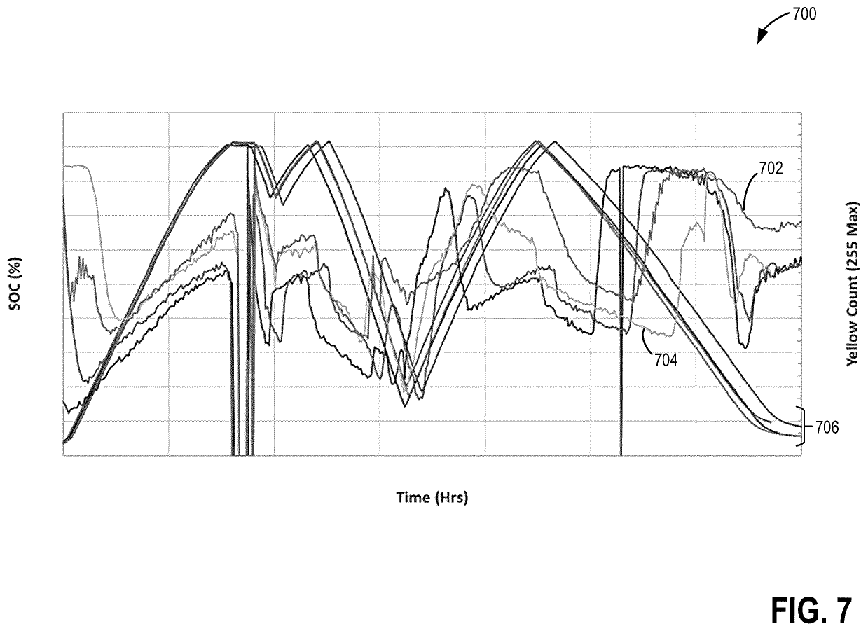

An effect of electrolyte volume rebalancing using a mixing valve on ferric iron (Fe³⁺) concentration in electrolyte of the negative electrolyte chamber of the multi-chambered electrolyte storage tank of FIG. 6 is depicted in a graph 700 in FIG. 7. Results provided by using the mixing valve are compared with results obtained without using the mixing valve. A SOC of an IFB of the redox flow battery system is shown along a first y-axis at a left side of graph 700 and a yellow count representing ferric iron concentration is shown along a second y-axis along a right side of graph 700. Time is shown along the x-axis of graph 700.

A first plot 702 of graph 700 represents ferric iron concentration with use of the mixing valve and a second plot 704 represents ferric iron concentration without use of the mixing valve. A set of plots 706 shows variations in the SOC over time. Electrolyte rebalancing using the mixing valve may result in an overall 10% higher ferric iron concentration in the electrolyte than without use of the mixing valve. Redistribution of the electrolyte via the mixing valve may therefore at least partially mitigate depletion of ferric iron in the negative electrolyte.

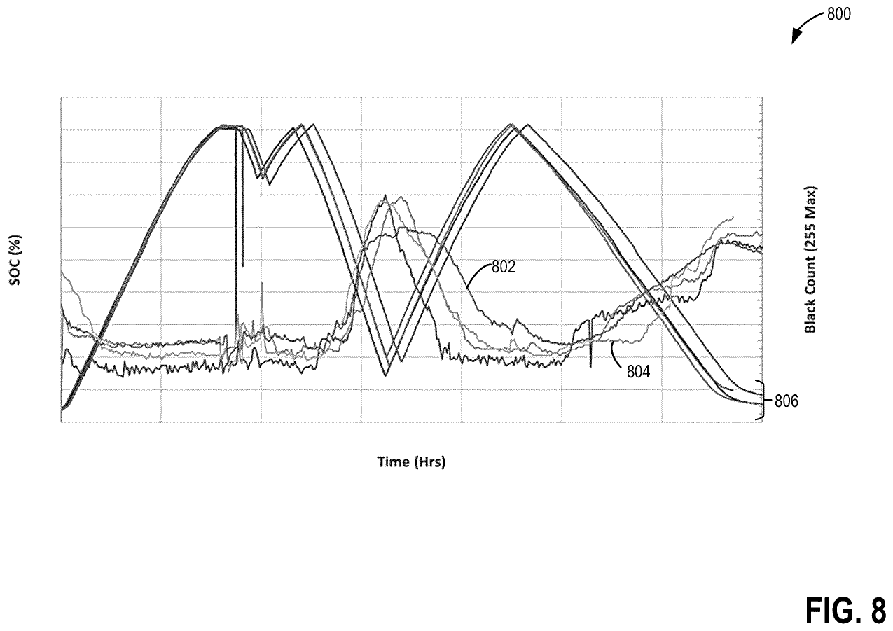

As shown in FIG. 8, a graph 800 depicts an effect of electrolyte volume rebalancing using the mixing valve on hydroxide concentration in the electrolyte of the negative electrolyte chamber. The multi-chambered electrolyte storage tank of FIGS. 6 and 7 is used to obtain data illustrated in FIG. 8, where graph 800 similarly depicts SOC along the first y-axis along the left side of graph 800 and time along the x-axis. Hydroxide concentration is indicated along a second y-axis of graph 800, along a right side of graph 800.

A first plot 802 of graph 800 represents hydroxide concentration in the negative electrolyte with use of the mixing valve. A second plot 804 of graph 800 represents hydroxide concentration without use of the mixing valve. A set of plots 806 shows variations in the SOC over time. Electrolyte rebalancing using the mixing valve results in more uniform hydroxide concentration across cycling of the redox flow battery system between charge and discharge modes. As such fluctuations in hydroxide concentration are less severe when the mixing valve is used.

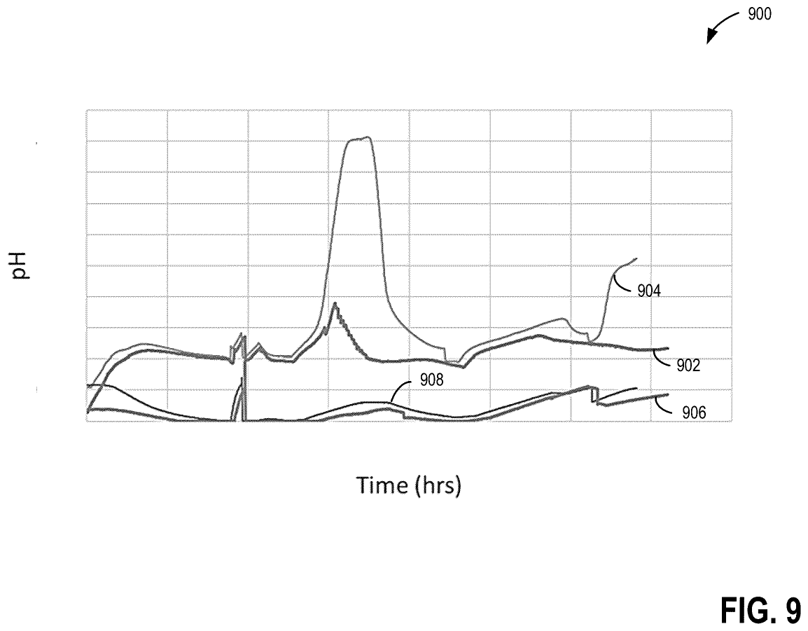

Implementation of the mixing valve for redistributing electrolyte may also stabilize electrolyte pH. For example, for the multi-chambered electrolyte storage tank of FIGS. 6-8, pH of electrolyte in the chambers may be monitored over time, as depicted in FIG. 9 in a graph 900. The electrolyte pH is shown along the y-axis of graph 900 and time is shown along the x-axis. Graph 900 includes a first plot 902, representing negative electrolyte with use of the mixing valve, and a second plot 904, representing negative electrolyte without use of the mixing valve. Graph 900 further includes a third plot 906, representing positive electrolyte with use of the mixing valve, and a fourth plot 908, representing positive electrolyte without use of the mixing valve. The use of the mixing valve may increase PH over time shown in the first plot 902 and second plot 904 compared to not using the mixing valve as shown in the third plot 906 and fourth plot 908.

Turning first to the negative electrolyte, use of the mixing valve reduces spikes and fluctuations in electrolyte pH relative to when the mixing valve is not used. For the positive electrolyte, fluctuations in pH are also suppressed when the mixing valve is used versus not used, although to a lesser extent than observed for the negative electrolyte. Mixing of electrolyte between the chambers, as provided by the mixing valve, may therefore reduce occurrence of undesirable side reactions in the redox flow battery system that drive increases in electrolyte pH that may otherwise promote formation of hydroxides.

The technical effect of method 400 is to equalize heights of electrolyte in negative and positive electrolyte chambers of a multi-chamber electrolyte storage tank. Mixing may be actively controlled by opening and closing of the mixing valve, based on the SOC of the redox flow battery system. In this way, the rebalancing of electrolyte may occur at a point in the charging cycle where compositions of the positive and negative electrolyte are similar and the mixing of electrolyte may be most beneficial to electrolyte health. Additionally, by positioning the mixing valve towards a bottom of the electrolyte chambers, the electrolyte flow may be driven by gravity and additional pumps are not demanded.

The disclosure also provides support for a redox flow battery system, comprising: an electrolyte storage tank having a first chamber and a second chamber, and a mixing valve fluidically coupling the first chamber to the second chamber, the mixing valve is selectively opened according to predetermined duty cycles to allow exchange of electrolyte between the first chamber and the second chamber. In a first example of the system, the mixing valve is located at bottoms of the first and second chambers, and wherein when the mixing valve is open, electrolyte flows through the mixing valve based on a pressure difference between the first chamber and the second chamber. In a second example of the system, optionally including the first example, the pressure difference between the first chamber and the second chamber is due to a difference in electrolyte height. In a third example of the system, optionally including one or both of the first and second examples, the predetermined duty cycles are estimated based on a countdown time and a state-of-charge (SOC) of the redox flow battery system. In a fourth example of the system, optionally including one or more or each of the first through third examples, each duty cycle of the predetermined duty cycles is shorter than a previous duty cycle, and wherein each duty cycle is a portion of a countdown time. In a fifth example of the system, optionally including one or more or each of the first through fourth examples, the mixing valve is selectively opened after the redox flow battery system is depleted. In a sixth example of the system, optionally including one or more or each of the first through fifth examples, the mixing valve is selectively opened during a charge cycle of the redox flow battery system. In a seventh example of the system, optionally including one or more or each of the first through sixth examples, the redox flow battery system includes an all-iron redox flow battery coupled to the electrolyte storage tank. In an eighth example of the system, optionally including one or more or each of the first through seventh examples, the electrolyte stored in the first chamber and the electrolyte stored in the second chamber have a common composition when the mixing valve is selectively opened.

The disclosure also provides support for a method for an electrolyte storage tank coupled to a redox flow battery, comprising: responsive to the redox flow battery being depleted, opening a mixing valve fluidically coupling a first chamber of the electrolyte storage tank to a second chamber of the electrolyte storage tank according to a plurality of duty cycles, each duty cycle of the plurality of duty cycles shorter than a previous duty cycle, to rebalance electrolyte volumes between the first chamber and the second chamber, and responsive to the redox flow battery being operated in a discharging mode, maintaining the mixing valve closed. In a first example of the method, the redox flow battery has a state-of-charge (SOC) of 0% when the redox flow battery is depleted, and wherein the mixing valve is opened during operation of the redox flow battery in a charging mode. In a second example of the method, optionally including the first example, the mixing valve is closed between each duty cycle of the plurality of duty cycles. In a third example of the method, optionally including one or both of the first and second examples, the electrolyte volumes of the first chamber and the second chamber are rebalanced when electrolyte heights in the first chamber and the second chamber are equal. In a fourth example of the method, optionally including one or more or each of the first through third examples, opening of the mixing valve according to the plurality of duty cycles is terminated before a SOC of the redox flow battery reaches 100%. In a fifth example of the method, optionally including one or more or each of the first through fourth examples, the electrolyte volumes between the first chamber and the second chamber are rebalanced before a SOC of the redox flow battery reaches 100%. In a sixth example of the method, optionally including one or more or each of the first through fifth examples, the mixing valve is opened in response to a difference between a concentration of supporting salts and electroactive materials in the first chamber and a concentration of supporting salts and electroactive materials in the second chamber being greater than a threshold difference, in addition to the redox flow battery being depleted.

The disclosure also provides support for an iron redox flow battery system, comprising: a multi-chambered electrolyte storage tank, an electrolyte stored in a first chamber and a second chamber of the multi-chambered electrolyte storage tank, and a mixing valve positioned at a bottom of the multi-chambered electrolyte storage tank and fluidically coupling the first chamber to the second chamber, wherein the mixing valve is pulsed open, according to a plurality of duty cycles determined based on a state-of-charge (SOC) of the iron redox flow battery system, to rebalance electrolyte volume between the first chamber and the second chamber when the iron redox flow battery system is at a 0% SOC. In a first example of the system, the plurality of duty cycles are durations of time for opening the mixing valve estimated based on, in addition to the SOC, one or more of a difference in electrolyte heights between the first chamber and the second chamber, a difference in concentrations of supporting salts and/or electroactive materials between the first chamber and the second chamber, and a flow rate through the mixing valve. In a second example of the system, optionally including the first example, electrolyte levels in the first chamber and the second chamber are maintained below a spillover hole of the multi-chambered electrolyte storage tank. In a third example of the system, optionally including one or both of the first and second examples, the bottom of the multi-chambered electrolyte storage tank is a region of the multi-chambered electrolyte storage tank below a fluid level of electrolyte stored in the first chamber and the second chamber of the multi-chambered electrolyte storage tank.

FIG. 2 shows an example configuration with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A redox flow battery system, comprising:
an electrolyte storage tank having a first chamber and a second chamber; and
a mixing valve fluidically coupling the first chamber to the second chamber, the mixing valve selectively opened according to predetermined duty cycles to allow exchange of electrolyte between the first chamber and the second chamber.

2. The redox flow battery system of claim 1, wherein the mixing valve is located at bottoms of the first and second chambers, and wherein when the mixing valve is open, electrolyte flows through the mixing valve based on a pressure difference between the first chamber and the second chamber.

3. The redox flow battery system of claim 2, wherein the pressure difference between the first chamber and the second chamber is due to a difference in electrolyte height.

4. The redox flow battery system of claim 1, wherein the predetermined duty cycles are estimated based on a countdown time and a state-of-charge (SOC) of the redox flow battery system.

5. The redox flow battery system of claim 1, wherein each duty cycle of the predetermined duty cycles is shorter than a previous duty cycle, and wherein each duty cycle is a portion of a countdown time.

6. The redox flow battery system of claim 1, wherein the mixing valve is selectively opened after the redox flow battery system is depleted.

7. The redox flow battery system of claim 1, wherein the mixing valve is selectively opened during a charge cycle of the redox flow battery system.

8. The redox flow battery system of claim 1, wherein the redox flow battery system includes an all-iron redox flow battery coupled to the electrolyte storage tank.

9. The redox flow battery system of claim 1, wherein the electrolyte stored in the first chamber and the electrolyte stored in the second chamber have a common composition when the mixing valve is selectively opened.

10. A method for an electrolyte storage tank coupled to a redox flow battery, comprising:
responsive to the redox flow battery being depleted;
opening a mixing valve fluidically coupling a first chamber of the electrolyte storage tank to a second chamber of the electrolyte storage tank according to a plurality of duty cycles, each duty cycle of the plurality of duty cycles shorter than a previous duty cycle, to rebalance electrolyte volumes between the first chamber and the second chamber; and
responsive to the redox flow battery being operated in a discharging mode;
maintaining the mixing valve closed.

11. The method of claim 10, wherein the redox flow battery has a state-of-charge (SOC) of 0% when the redox flow battery is depleted, and wherein the mixing valve is opened during operation of the redox flow battery in a charging mode.

12. The method of claim 10, wherein the mixing valve is closed between each duty cycle of the plurality of duty cycles.

13. The method of claim 10, wherein the electrolyte volumes of the first chamber and the second chamber are rebalanced when electrolyte heights in the first chamber and the second chamber are equal.

14. The method of claim 10, wherein opening of the mixing valve according to the plurality of duty cycles is terminated before a SOC of the redox flow battery reaches 100%.

15. The method of claim 10, wherein the electrolyte volumes between the first chamber and the second chamber are rebalanced before a SOC of the redox flow battery reaches 100%.

16. The method of claim 10, wherein the mixing valve is opened in response to a difference between a concentration of supporting salts and electroactive materials in the first chamber and a concentration of supporting salts and electroactive materials in the second chamber being greater than a threshold difference, in addition to the redox flow battery being depleted.

17. An iron redox flow battery system, comprising:
a multi-chambered electrolyte storage tank;
an electrolyte stored in a first chamber and a second chamber of the multi-chambered electrolyte storage tank; and
a mixing valve positioned at a bottom of the multi-chambered electrolyte storage tank and fluidically coupling the first chamber to the second chamber;
wherein the mixing valve is pulsed open, according to a plurality of duty cycles determined based on a state-of-charge (SOC) of the iron redox flow battery system, to rebalance electrolyte volume between the first chamber and the second chamber when the iron redox flow battery system is at a 0% SOC.

18. The iron redox flow battery system of claim 17, wherein the plurality of duty cycles are durations of time for opening the mixing valve estimated based on, in addition to the SOC, one or more of a difference in electrolyte heights between the first chamber and the second chamber, a difference in concentrations of supporting salts and/or electroactive materials between the first chamber and the second chamber, and a flow rate through the mixing valve.

19. The iron redox flow battery system of claim 17, wherein electrolyte levels in the first chamber and the second chamber are maintained below a spillover hole of the multi-chambered electrolyte storage tank.

20. The iron redox flow battery system of claim 17, wherein the bottom of the multi-chambered electrolyte storage tank is a region of the multi-chambered electrolyte storage tank below a fluid level of electrolyte stored in the first chamber and the second chamber of the multi-chambered electrolyte storage tank.
